(19) United States
(12) Patent Application Publication
(10) Pub. No.: US 2013/0145882 A1
(43) Pub. Date: Jun. 13, 2013

(54) Vibration Isolated Manual Transmission Shifter With Precise Shifting Feel

(71) Applicants: Larry G. Hartleip, Brighton, MI (US); George Krochmal, Linden, MI (US)

(72) Inventors: Larry G. Hartleip, Brighton, MI (US); George Krochmal, Linden, MI (US)

(73) Assignee: GM GLOBAL TECHNOLOGY OPERATIONS LLC, Detroit, MI (US)

(21) Appl. No.: 13/314,254

(22) Filed: Dec. 8, 2011

(51) Int. Cl. B60K 20/04

(52) U.S. Cl. 74/473.3

(57) ABSTRACT

A manual transmission shifter attachment arrangement which provides vibration isolation and precise shifting feel. A fore-aft movable attachment constrains movement of the shifter housing in all directions except a fore-aft direction. A fore-aft linkage causes the shifter housing to move in unison with the driveline in the fore-aft direction and reacts only to applied forces between the driveline and the shifter housing parallel to the fore-aft direction.

### TECHNICAL FIELD

The present invention relates to shifters used for driver selection of gears of a manual transmission. More particularly, the present invention relates to a shifter attachment arrangement which provides vibration isolation and precise shifting feel.

### BACKGROUND OF THE INVENTION

The engine in many rear-wheel-drive motor vehicles is mounted longitudinally and has a manual transmission attached solidly to the rear of the engine block. The engine and transmission collectively form a “powertrain”.

Combustion, inertia, and imbalance forces within the engine create low-amplitude, high-frequency vibrations which shake the entire powertrain. The strongest of these vibrations is in the torsional or “roll” axis around the engine crankshaft. The powertrain is typically attached to the structure of the motor vehicle via three powertrain mounts. The purpose of these mounts is to hold the powertrain securely within the motor vehicle while isolating the vibration created by the engine.

The powertrain undergoes another type of motion relative to the structure of the motor vehicle. This other type of motion has higher amplitude and lower frequency than the vibrations created by the engine. The sources of this type of motion include road inputs which cause the powertrain to move vertically, acceleration or deceleration events of the motor vehicle which cause fore-aft motion of the powertrain relative to the body, and torque reaction of the engine which causes the powertrain to roll slightly relative to the vehicle body.

The manual transmission contains multiple gears which the driver may select via a shift lever. The driver moves the lever fore-aft and laterally into distinct positions, each of which correlating to a desired gear of the transmission. The lower end of the shift lever interfaces with a shifter housing. Inside the shifter housing is a shifter mechanism which translates the fore-aft and lateral motion of the shift lever into fore-aft and rotational motion of a shift rod. The shift rod extends from inside the shifter housing and into the transmission. Fore-aft and rotational motion of the shift rod in response to movements of the shift lever results in movements inside the transmission which cause engagement of the desired gear. The shift rod has two U-joints located between the shifter housing and the transmission. These joints allow the powertrain to move vertically and laterally relative to the shifter housing, thereby decoupling powertrain vibration and motion from the shifter housing. Very little powertrain vibration or motion is transmitted from the transmission through the shift rod to the shifter housing.

The shifter housing is subjected to two major sources of force. The shifting forces transmitted through the shift rod in response to driver movement of the shift lever consist of rotational and fore-aft translational forces. These forces have the greatest effect on shifting precision. In order for gear selection to occur within the transmission, the fore-aft and rotational shift rod forces must be reacted in these same directions between the transmission and the shifter housing. Shifting forces from the shift lever into the shifter housing are strongest in the fore-aft and lateral directions and lower in the vertical direction. Therefore, some type of shifter attachment arrangement is required to constrain the shifter housing in the fore-aft, lateral, and torsional directions with respect to the transmission. In this regard, if the shifter housing is not constrained, the housing will translate and/or rotate when the shift lever is moved.

In the prior art, there are many ways known to structurally constrain (mount, attach, etc.) the shifter housing with respect to the transmission. Each such shifter attachment arrangement has an affect on the two dominant shifter performance metrics: shifting feel at the shift lever and the level of vibration transmitted from the transmission into the shifter, wherein not only can the vibration be felt at the shift lever, but it can also produce structure-borne noise if the vibration is transferred into the vehicle body. Accordingly, the ideal shifter attachment arrangement would provide both precise shifting feel and low as possible vibration levels. Unfortunately, it is very difficult to achieve both goals simultaneously in a shifter attachment arrangement. In this regard, the major variables to be considered in configuring a shifter attachment arrangement include: the stiffness, the location, and the geometry of the shifter attachment arrangement.

The stiffness of the shifter attachment arrangement greatly affects shifting feel. If the shifter housing is mounted stiffly with respect to the transmission, then the gear selections of the shift lever will feel precise due to mechanically stiff relationship between the transmission and the shifter housing. However, if the shifter housing is attached softly with respect to the transmission, then the gear selections of the shift lever will feel imprecise and rubbery due to the resilient movability of the shifter housing with respect to the transmission.

The location of the shifter attachment arrangement greatly affects the vibration levels in the shifter housing. In the prior art, the shifter is typically attached either to the transmission exclusively or to both the transmission and the vehicle body. Understandably, an attachment of the shifter housing exclusively to the transmission has the highest vibration level.

The geometry of the shifter attachment arrangement greatly affects the vibration levels transferred from the transmission into the shifter housing. In the prior art, a triangulated mounting geometry is known to be very stiff, but consequently, also very efficient at transferring vibration from the transmission to the shifter housing.

FIGS. 1 through 4 exemplify prior art shifter attachment arrangements.

FIGS. 1 and 2 depict a schematic view of a prior art shifter attachment arrangement 10 of a shifter 11 for a manual transmission 14 of a driveline 12, wherein the shifter housing 22 of the shifter 10 is connected exclusively to the driveline at the transmission. A flexible boot 28 is interfaced between the vehicle body 24 (e.g., the “tunnel” 25) and the shifter housing 22, but does not provide support of the shifter housing. The shifter 11 is operably connected to the driveline 12 at the transmission 14 via an articulated shift rod 18 having a pair of U-joints 19, wherein the transmission has a propeller (or drive) shaft 16 connected thereto. Gears of the transmission are driver selected by the driver grasping of a pivotally mounted shift lever 20 of the shifter 11 and moving it into selected gear positions. The shifter housing 22 is connected to the driveline 12 at the transmission 14 via a set of rigid arms which are triangulated in the form of a pair of arms 30 which are laterally acutely angled in relation to a respective side of the shifter housing and a central rigid arm 31 which is vertically acutely angled with respect to the bottom of the shifter housing. The connection of the arms 30, 31 to the transmission 14 is via a joint 32 which may or may not include an elastomeric isolator 34 therewithin.

In this shifter attachment arrangement 10, the powertrain vibration is effectively transferred directly into the shifter 11 from the transmission 14. In this regard, since the dominant powertrain vibration is torsional roll motion around the crankshaft, this torsional motion is registered as lateral vibration at the shifter attachment location, due to the fact it is located above the crankshaft. While attaching the shifter solidly to the transmission produces the most vibration at the shifter housing, this shifter attachment arrangement provides a precise shifting feel at the shift lever. Providing isolation at the attachments (such as by the elastomeric isolator 34) will lower vibration levels from the transmission to the shifter housing; however, this will degrade shifting precision such that the shifting feel will be less stiffly mechanical and more rubbery. Accordingly, the attachment of the shifter housing exclusively to the transmission (or drivetrain) is typically a shifter attachment arrangement that is used in performance vehicles, where shifting precision is more valued than is vibration isolation.

FIGS. 3 and 4 depict a schematic view of a prior art shifter attachment arrangement 10′ of a shifter 11′ for a manual transmission 14′, of a driveline 12′, wherein the shifter housing 22′ of the shifter 11′ is connected to both the driveline at the transmission and, via a resilient pad 28, to the vehicle body 24′ (e.g., the tunnel 25′). As in FIG. 1, the shifter 11′ is operably connected to the driveline 12′ at the transmission 14′ via an articulated shift rod 18′ having a pair of U-joints 19′, wherein the transmission has a propeller (or drive) shaft 16′ connected thereto. Gears of the transmission are driver selected by the driver grasping of a shift lever 20′ of the shifter 11′ and moving it into selected gear positions. The shifter housing 22′ is connected to the driveline 12′ at the transmission 14′ via a pair of rigid arms 30′ which are laterally acutely angled in relation to a respective side of the shifter housing. The connection of the arms 30′ to the transmission 14′ is via a joint 32′ which preferably includes an elastomeric isolator 34′ therewithin. Additionally, the shifter 11′ is connected to the vehicle body 24′, more particularly the tunnel 25′ of the vehicle body, via a non-resilient mounting frame 26 which is affixed to the tunnel 25′ and to the above mentioned resilient mounting pad 28, for example composed of rubber, which is affixed to both the mounting frame and the shifter housing 22′.

This shifter attachment arrangement 10′ is very common in the prior art to provide mounting of shifters that utilize shift rods instead of shift cables. In this regard, most manual transmission shifters use either shift rods or cables to transfer motion and force from the shifter to the transmission. Cable operated shifters are typically better isolated from powertrain vibration but are less precise with a rubbery feel and greater shift efforts due to cable friction and flexibility. Prior art shifters utilizing shift rods display higher shifting precision due to the solid shift rod and lighter shift efforts due to lower friction but suffer from poor vibration isolation.

The shifter housing 22′ and the arms 30′ form a solid unit, wherein a forward end of this unit is attached to the transmission and a rearward end of this unit is attached to the vehicle body. These attachments can be configured to be very stiff or very soft, and this leads to numerous subtleties that are not immediately evident.

If the forward and rearward attachments are extremely stiff, then the shifter attachment arrangement 10′ would be mechanically rigid, resulting in no vibration isolation as between the powertrain and the vehicle body. Shifting would feel very precise to the driver because the shifter housing would not move relative to the transmission while it is subjected to shifting forces from the shift rod in response to driver movement of the shift lever. Unfortunately, all of the powertrain vibration would be passed into the vehicle body causing high levels of structure-borne noise and uncomfortable levels of shift lever vibration for the driver. A solid attachment would also interfere with relative dynamic motion of the transmission with respect to the vehicle body, whereby a highly stiff shifter attachment arrangement is not implementable in practice.

On the other hand, if the forward and rearward attachments are extremely soft, then the shifter attachment arrangement 10′ would be mechanically springy, resulting in a high level of vibration isolation as between the powertrain and the vehicle body. Shifting would feel very rubbery to the driver because shifting forces from the shift rod in response to movements of the shift lever would move the shifter housing relative to the transmission. While mounting the shifter housing very softly would isolate the vehicle body from some of the powertrain vibration and some of the dynamic powertrain motion, unfortunately the acutely angled lateral geometry of the attachment arms between the shifter housing and the transmission creates a very efficient path for transferring the strong lateral powertrain vibrations to the shifter housing and into the vehicle body.

Since both of the extremely stiff and extremely soft shifter attachment arrangements 10′ provide unacceptable performance, the typical shifter attachment arrangement 10′ that is used in practice falls somewhere in-between these two extremes, whereby a best possible compromise is made between precise shift feel and vibration isolation, per the criteria appropriate to a particular motor vehicle. Unfortunately, this compromise typically results in a shifter attachment arrangement that performs below the desired performance targets for both vibration isolation and shifting precision.

Accordingly, what is needed in the art is a shifter attachment arrangement for a manual transmission which isolates the shifter housing from vibration of the drivetrain (including that of the powertrain) and simultaneously also provides a precise shifting feel.

### SUMMARY OF THE INVENTION

The present invention is a vibration isolated, precision shifting feel shifter attachment arrangement for a manual transmission of a motor vehicle, wherein the shifter attachment arrangement includes both a fore-aft movable attachment of the shifter housing with respect to the vehicle body and a fore-aft linkage between the shifter housing and the driveline, in particular the transmission thereof.

In order to achieve precision shifting feel, the fore-aft movable attachment must provide adequate torsional constraint. Accordingly, the fore-aft movable attachment allows the shifter housing to follow in unison the fore-aft movements of the driveline responsive to the fore-aft linkage. At the same time, the fore-aft movable attachment constrains movement of the shifter housing relative to the vehicle body in all directions except the fore-aft direction.

The fore-aft linkage connects the shifter housing to the transmission and constrains fore-aft movement of the shifter housing relative to the transmission. In addition, the fore-aft linkage in combination with the fore-aft movable attachment prevent shift lever wobble (pivoting of the shift lever in response to a fore-aft movement of the driveline caused by the shifter housing not moving in unison with the fore-aft movement of the driveline), whereby relative motion between the transmission and the shifter housing is prevented.

The fore-aft linkage reacts to applied forces in-line therewith only, all other directions having no force reaction due to the presence of a “heim joint” being disposed at each end of the fore-aft linkage. A heim joint is an articulating joint, sometimes referred to as a “spherical rod end” or a “rod end bearing”, that features a rotating, spherical ball-joint which only reacts to forces applied in-line with the rod to which it is attached. Accordingly, the fore-aft linkage is connected between the transmission and the shifter housing such that it reacts only to forces applied in the fore-aft direction of motion. The fore-aft linkage provides movement constraint of the shifter housing with respect to the transmission for applied shift rod forces originating from driver shift lever movements, whereby the shifting is mechanically stiff, resulting in a shifting feel that is precise. At the same time, the fore-aft linkage, due to the heim joints, prevents the strong lateral powertrain vibration and movement from being transmitted to the shifter housing.

Accordingly, it is an object of the shifter attachment arrangement according to the present invention to provide vibration isolation of the shifter housing from the powertrain, accommodation of movements of the drivetrain relative to the vehicle body, and precise shifting feel.

This and additional objects, features and advantages of the present invention will become clearer from the following specification of a preferred embodiment.

### BRIEF DESCRIPTION OF THE DRAWINGS

FIG. 1 is a schematic side view of a prior art shifter attachment arrangement in which the shifter housing is exclusively attached to the transmission.

FIG. 2 is a schematic plan view of the prior art shifter attachment arrangement of FIG. 1, seen along line 2-2 of FIG. 1.

FIG. 3 is a schematic side view of a prior art shifter attachment arrangement in which the shifter housing is attached to both the transmission and the vehicle body.

FIG. 4 is a schematic plan view of the prior art shifter attachment arrangement of FIG. 3, seen along line 4-4 of FIG. 3.

FIG. 5 is a schematic side view of a shifter attachment arrangement according to a theoretical form of the present invention and provided for instructional purposes, in which the shifter housing is exclusively attached to the vehicle body.

FIG. 6 is a schematic plan view of the shifter attachment arrangement of FIG. 5, seen along line 6-6 of FIG. 5.

FIG. 7 is a schematic side view of a shifter attachment arrangement according to a most preferred form of the present invention.

FIG. 8 is a schematic plan view of the shifter attachment arrangement of FIG. 7, seen along line 8-8 of FIG. 7.

FIG. 9 is a schematic partly sectional view of the shifter attachment arrangement of FIG. 7, seen along line 9-9 of FIG. 7.

FIG. 10 is a schematic side view of a shifter attachment arrangement of FIG. 7, shown now in response to an aft movement of the driveline.

FIG. 11 is a schematic side view of a shifter attachment arrangement of FIG. 7, shown now in response to a fore movement of the driveline.

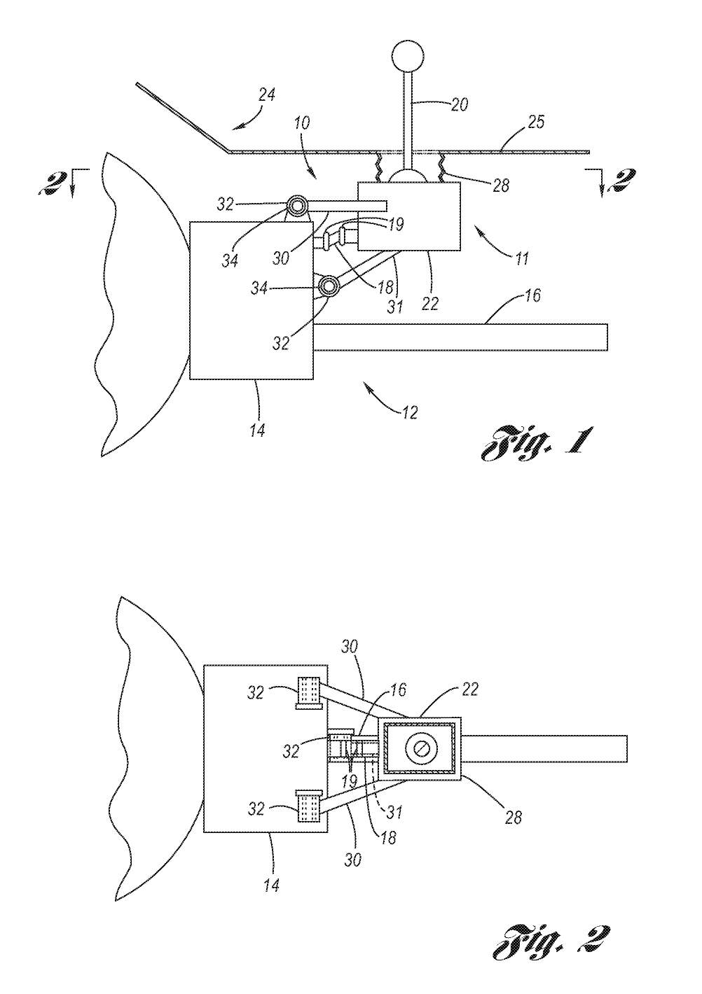

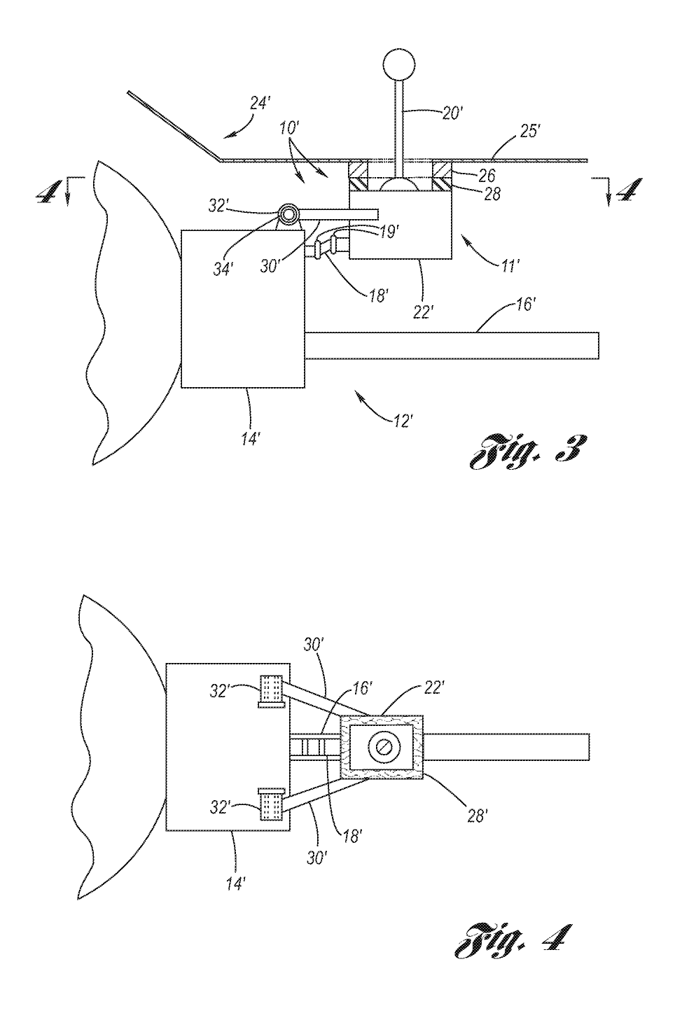

### DESCRIPTION OF THE PREFERRED EMBODIMENT

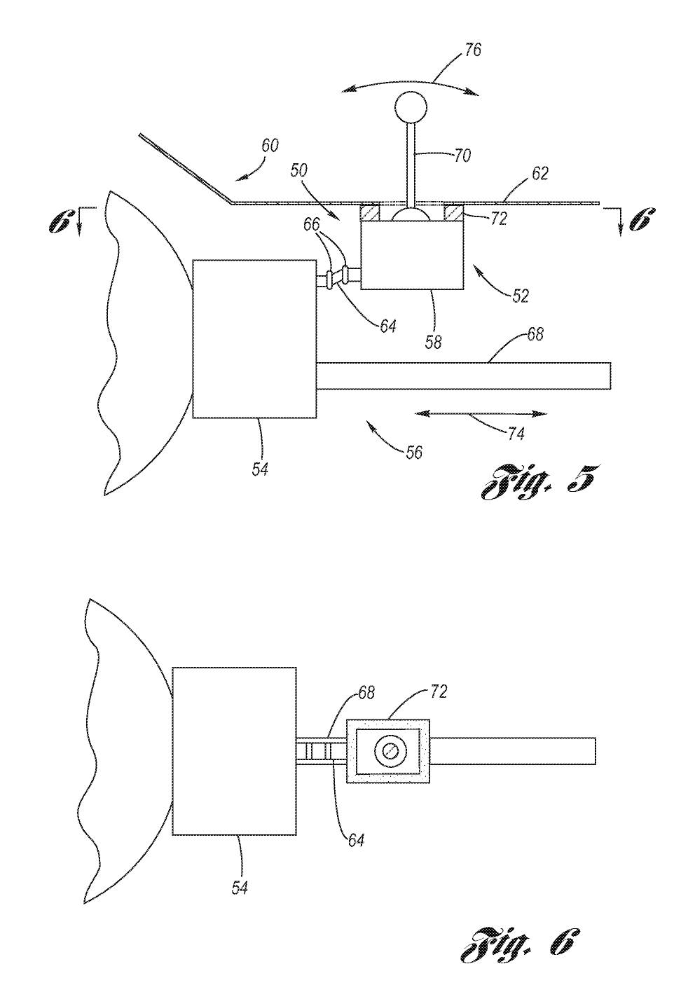

Referring firstly to FIGS. 5 and 6, depicted are schematic views of a shifter attachment arrangement 50 of a shifter 52 for a manual transmission 54, of a driveline 56, wherein the shifter housing 58 of the shifter 52 is connected exclusively to the vehicle body 60 (e.g., the tunnel 62), presented for instructional purposes. The shifter 52 is operably connected to the driveline 56 at the transmission 54 via an articulated shift rod 64 having a pair of U-joints 66, wherein the transmission has a propeller (or drive) shaft 68 connected thereto. Gears of the transmission 54 are driver selected by the driver grasping a shift lever 70 of the shifter 52 and moving it into selected gear positions. The shifter housing 58 is connected to the vehicle body 60, more particularly the tunnel 62 of the vehicle body, via a non-resilient mounting frame 72 which is affixed to the tunnel 62 and the shifter housing 58.

In the shifter attachment arrangement of FIGS. 5 and 6, the vehicle body 60 will be subject to very low drivetrain vibration levels because the only interface therebetween is the articulated shift rod 64. As such, this shifter attachment arrangement 50 provides excellent vibration isolation. Additionally, since the shifter housing 58 is affixed securely to the vehicle body in stationary relation thereto, the shifting feel of the shift lever is precise due to the reaction forces of the shift rod with respect to the transmission being rigidly mechanical. Unfortunately, this rigidly mechanical relationship results in the appearance of “shift lever wobble”.

The relatively slight fore-aft motion 74 of the driveline with respect to the vehicle body during events of vehicle operation results in the shift rod 64 causing the connection end of shift lever 70 to similarly fore-aft move. Due to the high mechanical lever ratio of the shift lever (wherein the distance between its pivot and its shift rod connection end is much smaller than the distance between its pivot and its driver grasping handle end), the slight fore-aft motion of the shift rod at the connection end results in a relatively large reverse motion of the shift rod. This fore-aft motion of the shift lever is referred to as “wobble” 76 of the handle end of the shift lever. This shift lever wobble 76 is highly undesirable and renders the shift lever attachment arrangement 50 impractical. For that reason, this form of the present invention is not preferred.

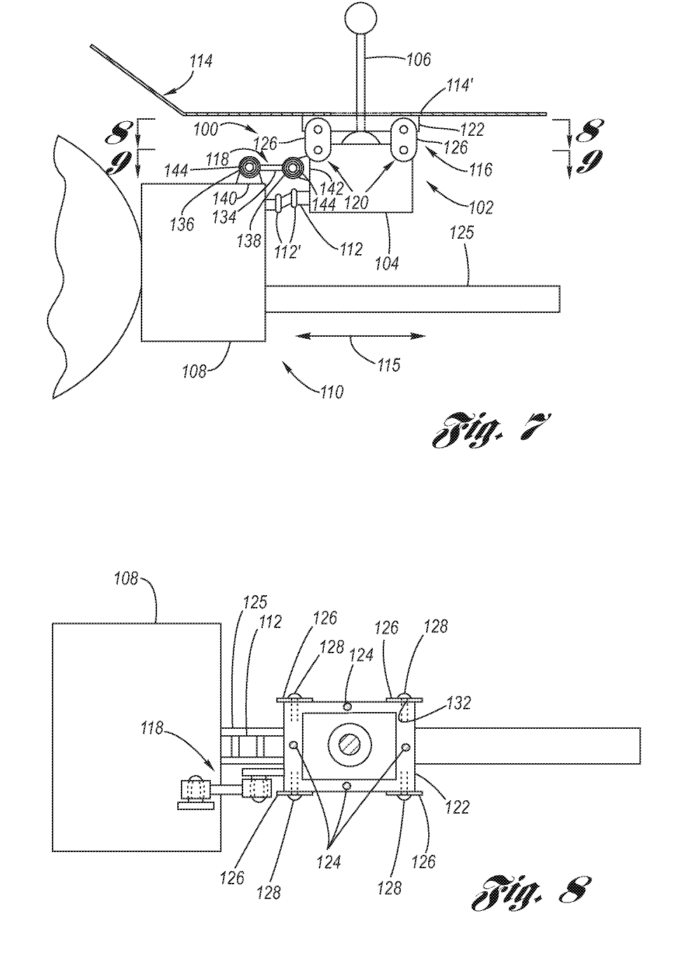

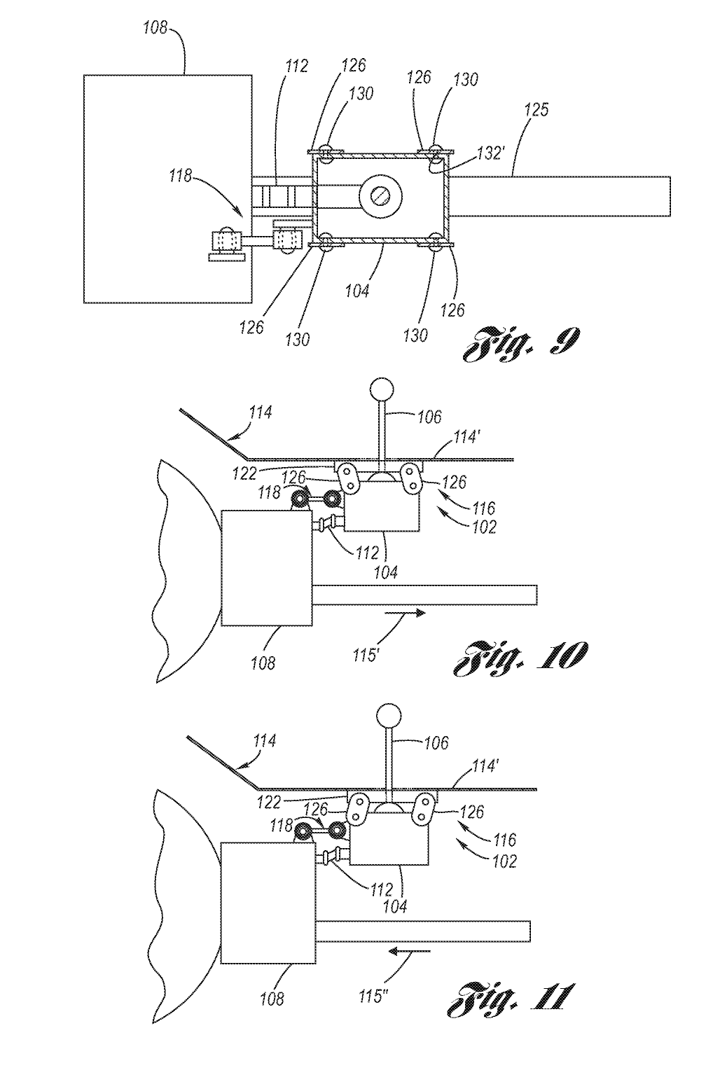

Referring now to FIGS. 7 through 11, a shifter attachment arrangement 100 according to a preferred form of the present invention is depicted which provides all the advantages of the shifter attachment arrangement 50, while eliminating shift lever wobble.

The shifter 102 includes a shifter housing 104 and a shift lever 106, wherein the shift lever is movable with respect to the shifter housing to a number of gear selection locations accomplished by a driver grasping the shift lever. In this regard, the aforementioned movement of the shift lever 106 results in related gear selection at the transmission 108 of a driveline 110 via a shift rod 112 having U-joints 112′ for articulation. The shift rod 112 serves to connect the shift lever to the transmission for gear selection in a conventionally known manner. The driveline includes a drive (or propeller) shaft 125 and the transmission is connected to an internal combustion engine (not shown), forming a powertrain also in a conventionally known manner.

The shifter attachment arrangement 100 includes a fore-aft movable attachment 116 of the shifter housing 104 with respect to the vehicle body 114 and a fore-aft linkage 118 between the shifter housing and the driveline 110, in particular the transmission 108 thereof.

In order to achieve precision shifting feel, the fore-aft movable attachment must provide adequate torsional constraint. Accordingly, the fore-aft movable attachment 116 allows the shifter housing to follow in unison the fore-aft movements of the driveline responsive to the fore-aft linkage 118. At the same time, the fore-aft movable attachment 116 constrains movement of the shifter housing 104 relative to the vehicle body 114 in all directions except the fore-aft direction 115.

The singular fore-aft linkage 118 connects the shifter housing 104 to the transmission 108 and constrains fore-aft movement of the shifter housing relative to the transmission. In addition, the fore-aft linkage 118, in combination with the fore-aft movable attachment 116, prevents shift lever wobble because it eliminates relative motion between the transmission and the shifter housing.

The fore-aft linkage 118 is composed of a rigid member 134, as for example a metallic rod or bar, having at one end thereof a first heim joint 136 connected to the transmission 108 by a first mounting member 140, and having at the opposite end thereof a second heim joint 138 connected to the shifter housing 104 by a second mounting member 142. The fore-aft linkage 118 is connected to the transmission and the shifter housing such that the fore-aft linkage reacts only to forces applied in the fore-aft direction of motion, wherein for forces in all other directions, there is no force reaction due to the presence of the heim joints 136, 138. The fore-aft linkage 118 provides movement constraint of the shifter housing 104 with respect to the transmission 108 for applied forces of the shift rod 112 originating from driver initiated movements of the shift lever 106, whereby the gear shifting is mechanically stiff, resulting in a shifting feel that is precise. At the same time, the fore-aft linkage 118, due to the heim joints 136, 138, prevents the strong lateral powertrain vibration from being transmitted to the shifter housing 104. Elastomeric isolators 144 may or may not be disposed in the heim joints 136, 138, wherein the elastomeric isolators may be tuned to provide a desired level of softening of the mechanical stiffness of the gear shifting as is appropriate for a particular motor vehicle.

By way of example, the fore-aft movable attachment 116 is in the form of a pivoting four-link system 120. A non-resilient mounting frame 122 is attached to the tunnel 114′ of the vehicle body 114 via, for example, threaded fasteners 124 (see FIG. 8). The pivoting four-link system 120 is composed of four pivot links 126. Each pivot link 126 has a pair of mutually spaced apart pivot holes 132, 132′. One end portion of each pivot link 126 122 is connected, via the mounting hole 132, to the mounting frame 122, utilizing, for example, a rivet, pin, or other fastener 128 that allows pivoting at the mounting hole 132. The other end portion of each pivot link 126 is connected, via the mounting hole 132′, to the shifter housing 104, utilizing, for example, a rivet, pin, or other fastener 130 that allows pivoting at the mounting hole 132′.

It is to be understood that while the fore-aft movable attachment 116 is preferred to be the above described pivoting four-link system 120 for reasons of economy and simplicity, any other mechanical configuration which allows for fore-aft movement while constraining all other directions of motion, such as a ball or roller bearing mechanism or a slide, can also be utilized in substitution therefor.

Turning attention now with more particularity to FIGS. 10 and 11, operation of the shifter attachment arrangement 100 will be exemplified.

Comparing FIGS. 7 and 10, the driveline 110 has undergone an aft movement 115′ relative to the vehicle body 114. The fore-aft linkage 118 has caused the shifter housing 104 to move aft in unison with the aft movement of the driveline. During the aft movement of the shifter housing 104 relative to the vehicle body 114, the pivot links 126 have pivoted relative to the mounting frame 122 and the shifter housing so as to accommodate the aft movement of the shifter housing. All the while during this aft movement, the fore-aft movable attachment 116 provides constraint of movement of the shifter housing relative to the vehicle body in all directions other than fore-aft.

Comparing FIGS. 7 and 11, the driveline 110 has undergone a fore movement 115″ relative to the vehicle body 114. The fore-aft linkage 118 has caused the shifter housing 104 to move fore in unison with the fore movement of the driveline. During the fore movement of the shifter housing 104 relative to the vehicle body 114, the pivot links 126 have pivoted relative to the mounting frame 122 and the shifter housing so as to accommodate the fore movement of the shifter housing. All the while during this fore movement, the fore-aft movable attachment 116 provides constraint of movement of the shifter housing relative to the vehicle body in all directions other than fore-aft.

From the foregoing, it is to be understood that the shifter attachment arrangement 100 in accordance with the present invention serves to advantageously isolate the shifter housing from powertrain vibration, particularly strong lateral powertrain vibration, and provide a satisfying precise shifting feel for the driver, wherein shift lever wobble has been eliminated.

To those skilled in the art to which this invention appertains, the above described preferred embodiment may be subject to change or modification. Such change or modification can be carried out without departing from the scope of the invention, which is intended to be limited only by the scope of the appended claims.

1. An attachment arrangement for a shifter of a motor vehicle, comprising:
a shifter comprising a shifter housing and a shift lever movably connected to said shifter housing;
a motor vehicle body;
a driveline having a fore-aft direction;
a fore-aft movable attachment connecting said shifter housing to said motor vehicle body, said fore-aft movable attachment constraining movement of said shifter housing relative to said vehicle body in all directions of movement except in the fore-aft direction; and
a fore-aft linkage connecting said shifter housing to said driveline;
wherein said fore-aft linkage moves said shifter housing fore-aft in unison with fore-aft movement of said driveline with respect to said vehicle body; and
wherein said fore-aft movable attachment enables said shifter housing to move fore-aft with respect to said vehicle body.

2. The attachment arrangement of claim 1, wherein said fore-aft linkage comprises:
a first heim joint connected to said driveline;
a second heim joint connected to said shifter housing; and
a rigid member connecting to each of said first and second heim joints;
wherein said fore-aft linkage reacts only to applied forces between said driveline and said shifter housing which are aligned in parallel with the fore-aft direction.

3. The attachment arrangement of claim 2, wherein said driveline comprises a transmission; further comprising a shifter rod connecting said shift lever to said transmission, wherein movement of said shift lever effects gear shifting in said transmission via said shifter rod; wherein said fore-aft linkage constrains movement of said shifter housing with respect to said transmission such that the gear shifting occurs with a mechanical stiffness which provides a precise shifting feel at said shift lever.

4. The attachment arrangement claim 3, wherein at least one of said first and second heim joints includes an elastomeric isolator therewithin, wherein said elastomeric isolator provides a predetermined softening of said mechanical stiffness with respect to the effecting of shifting of gears.

5. The attachment arrangement of claim 3, wherein said fore-aft movable attachment comprises a pivoting four-link system.

6. The attachment arrangement of claim 5, wherein at least one of said first and second heim joints includes an elastomeric isolator therewithin, wherein said elastomeric isolator provides a predetermined softening of said mechanical stiffness with respect to the effecting of shifting of gears.

7. An attachment arrangement for a shifter of a motor vehicle, comprising:
a shifter comprising a shifter housing and a shift lever movably connected to said shifter housing;
a motor vehicle body;
a driveline comprising a manual transmission, said driveline having a fore-aft direction;
a fore-aft movable attachment connecting said shifter housing to said motor vehicle body, said fore-aft movable attachment constraining movement of said shifter housing relative to said vehicle body in all directions of movement except in the fore-aft direction; and
a fore-aft linkage connecting said shifter housing to said transmission, said fore-aft linkage comprising:
a first heim joint connected to said transmission;
a second heim joint connected to said shifter housing; and
a rigid member connecting to each of said first and second heim joints;
wherein said fore-aft linkage reacts only to applied forces between said driveline and said shifter housing which are aligned in parallel with the fore-aft direction;
wherein said fore-aft linkage moves said shifter housing fore-aft in unison with fore-aft movement of said driveline with respect to said vehicle body; and
wherein said fore-aft movable attachment enables said shifter housing to move fore-aft with respect to said vehicle body.

8. The attachment arrangement of claim 7, further comprising a shifter rod connecting said shift lever to said transmission, wherein movement of said shift lever effects gear shifting in said transmission via said shifter rod; wherein said fore-aft linkage constrains movement of said shifter housing with respect to said transmission such that the gear shifting occurs with a mechanical stiffness which provides a precise shifting feel at said shift lever.

9. The attachment arrangement claim 8, wherein at least one of said first and second heim joints includes an elastomeric isolator therewithin, wherein said elastomeric isolator provides a predetermined softening of said mechanical stiffness with respect to the effecting of shifting of gears.

10. The attachment arrangement of claim 7, wherein said fore-aft movable attachment comprises a pivoting four-link system.

11. The attachment arrangement of claim 10, further comprising a shifter rod connecting said shift lever to said transmission, wherein movement of said shift lever effects gear shifting in said transmission via said shifter rod; wherein said fore-aft linkage constrains movement of said shifter housing with respect to said transmission such that the gear shifting occurs with a mechanical stiffness which provides a precise shifting feel at said shift lever.

12. The attachment arrangement claim 11, wherein at least one of said first and second heim joints includes an elastomeric isolator therewithin, wherein said elastomeric isolator provides a predetermined softening of said mechanical stiffness with respect to the effecting of shifting of gears.

13. An attachment arrangement for a shifter of a motor vehicle, comprising:
a shifter comprising a shifter housing and a shift lever movably connected to said shifter housing;
a motor vehicle body;
a driveline comprising a manual transmission, said driveline having a fore-aft direction;
a fore-aft movable attachment connecting said shifter housing to said motor vehicle body, said fore-aft movable attachment comprising a pivoting four-link system constraining movement of said shifter housing relative to said vehicle body in all directions of movement except in the fore-aft direction; and
a fore-aft linkage connecting said shifter housing to said transmission, said fore-aft linkage comprising:
a first heim joint connected to said transmission;
a second heim joint connected to said shifter housing; and
a rigid member connecting to each of said first and second heim joints;
wherein said fore-aft linkage reacts only to applied forces between said driveline and said shifter housing which are aligned in parallel with the fore-aft direction;
wherein said fore-aft linkage moves said shifter housing fore-aft in unison with fore-aft movement of said driveline with respect to said vehicle body; and
wherein said fore-aft movable attachment enables said shifter housing to move fore-aft with respect to said vehicle body.

14. The attachment arrangement of claim 13, further comprising a shifter rod connecting said shift lever to said transmission, wherein movement of said shift lever effects gear shifting in said transmission via said shifter rod; wherein said fore-aft linkage constrains movement of said shifter housing with respect to said transmission such that the gear shifting occurs with a mechanical stiffness which provides a precise shifting feel at said shift lever.

15. The attachment arrangement claim 14, wherein at least one of said first and second heim joints includes an elastomeric isolator therewithin, wherein said elastomeric isolator provides a predetermined softening of said mechanical stiffness with respect to the effecting of shifting of gears.
